(19) United States
(12) Patent Application Publication
(10) Pub. No.: US 2010/0205454 A1
(43) Pub. Date: Aug. 12, 2010

(54) CIPHER DATA BOX

(76) Inventors: Victor Chuan-Chen WU, Cupertino, CA (US); Bill Kwong, Saratoga, CA (US)

Correspondence Address: SINORICA, LLC, 2275 Research Blvd., Suite 500, ROCKVILLE, MD, 20850, US

(21) Appl. No.: 12/367,598

(22) Filed: Feb. 9, 2009

(51) Int. Cl. H04L 9/06

(52) U.S. Cl. 713/189

(57) ABSTRACT

A cipher data box comprises: a housing; a printed circuit board; a first connector; a second connector; a controller, having a unique first identification code; a key seat; and a key, having a unique second identification code; therefore, when the key is inserted into the key seat and the first identification code is same as the second identification code, the storage device can be normally accessed, and the data therein will be encrypted/decrypted. Furthermore, for further enhancing the security function of the storage device, a plurality of cipher data boxes of the present invention can be cascade each other.

### BACKGROUND OF THE INVENTION

1. Field of the Invention

The present invention relates to a cipher data box that enables different types of storage devices to be conveniently encrypted/decrypted, so as to achieve the goal of protecting the data of the storage devices.

2. Description of Related Art

A standard desktop computer typically provides one or more compartments (also called drive bays) for the installation of 5¼ inch or 3½ inch storage devices such as CD ROM, DVD ROM or CDRW drive, hard drive, ZIP, SuperDisk etc. Because of space limitation, many desktop computers, Kiosk or computing equipment have only one to two drive bays, thus limiting the number of devices that can be installed. Once a storage device is installed into the drive compartment or drive bay, replacement or upgrade of the storage device requires careful disassembling and reassembling of the computer by a trained technician.

Data storage devices primary fall into two categories: the removable storage and hard disk storage. These two types of data storage devices offer different advantages depending on the type of applications.

In the removable storage, the storage media can be replaced as more storage space is needed. Cost of the media is relatively inexpensive. But the data transfer rate for removable storage devices in general are much slower than hard disk storage. Thus the removable storage is great for data archiving. To access the data stored on a removable storage media, the computer must have a compatible drive that can read the data from the media. Example, a CDRW drive or CD-ROM drive is needed to access the data on a CDRW media, a DVD drive is needed to access data on a DVD media, a 250 MB-ZIP drive is needed to access data on a 250 MB ZIP media. As a result, in order for a computer to access data on a variety of removable media, it must be equipped with various types of drives.

In the case of hard disk storage, the media and the drive are integrated together. With this design, the data transfer rate for hard drive is much faster than the removable storage. Thus hard disk is great for storing program files, for storing data that are accessed all the time and for streaming video application. Since the hard drive and the storage media are all integrated in one unit, the computer can access the data stored in a hard drive by connecting up the hard disk controller cable and the power cable from inside a computer to the hard drive. But this way of connecting a hard drive to a computer usually requires opening up the computer and technical skill.

External hard drive solves the problem of connecting a drive to a computer without opening up the computers. The external hard drives attach to a computer via one of the common I/O ports on a computer: USB, Firewire or PCMCIA. Since all the external hard drives are constructed with an enclosure to house the hard drive and the interface electronics. The additional cost of the housing and interface electronics make the external hard drive much more expensive than an internal IDE drive. So when an external hard drive capacity is used up, the user will have to purchase another external hard drive in order to have more data storage capacity. In addition, the external hard drive with this traditional design also limits its use to a single interface. If you have an external USB hard drive, a computer that has no USB port will not be able to use the hard drive.

Please refer to FIG. 1, which shows a disassembly schematic of a prior art external hard disk driver with data encryption/decryption function. As shown in the Fig., the prior art external hard disk driver with data encryption/decryption function normally comprises a housing 100, and a controller 100 with the ability of executing encryption/decryption function, user can put a storage device for example but not limited to a hard disk driver (HDD) or Solid State Disk (SSD) 120 into the housing 100 and connect to the controller 110, then connects to a computer or equipment via an interface 130, for example but not limited to a USB interface, thus, the controller 110 will execute the encryption/decryption function for the data of the hard disk driver 120. But when the housing 100 and hard disk driver 120 are stolen together, the hard disk driver 120 will lose its protecting function. Additionally, when the user buys a new hard disk driver 120, he (she) still needs to buy another new housing 100 due to the controller 110 is normally bonded in the housing 100, thus will increase the user's cost. Or, the user can swap more than one hard disk drivers 120 in the housing 100, but thus will cause inconveniently to the user.

Furthermore, if a hard disk driver installed in a computer system wishes to have the data encryption/decryption function, the aforesaid prior art external hard disk driver will not suitable due to it cannot be installed in the housing of the computer system.

Therefore, the solution or invention in this patent deals with a cipher data box that enables different types of storage devices to be conveniently encrypted/ decrypted, so as to achieve the goal of protecting the data of the storage devices.

### SUMMARY OF THE INVENTION

The object of the present invention is to provide a cipher data box that enables different types of storage devices to be conveniently encrypted/decrypted, so as to achieve the goal of protecting the data of the storage devices.

According to one non-limited embodiment of the present invention, the cipher data box that can encrypt/decrypt the data of a storage device of a computer or equipment, comprising: a housing, having a space and at least one opening and a hole; a printed circuit board, disposed in the space; a first connector, disposed in the printed circuit board and exposed the opening, for connecting to a storage device; a second connector, disposed in the printed circuit board and exposed the opening, for connecting to a storage device control circuit of the computer or equipment; a controller, disposed in the printed circuit board and connecting to the first connector and second connector, respectively, for encrypting/decrypting the data of the storage device then outputting, and having a unique first identification code; a key seat, exposed the hole, and connecting to the controller via wires; and a key, for inserting into the key seat, having a circuit for executing the encrypting/decrypting function same as the controller, and having a unique second identification code; therefore, when the key is inserted into the key seat and the first identification code is same as the second identification code, the storage device can be accessed, and the data therein will be encrypted/decrypted.

### BRIEF DESCRIPTION OF THE DRAWINGS

The present invention can be more fully understood by reference of the following description and accompanying drawings, in which:

FIG. 1 illustrates a disassembly drawing of the prior art external hard disk driver.

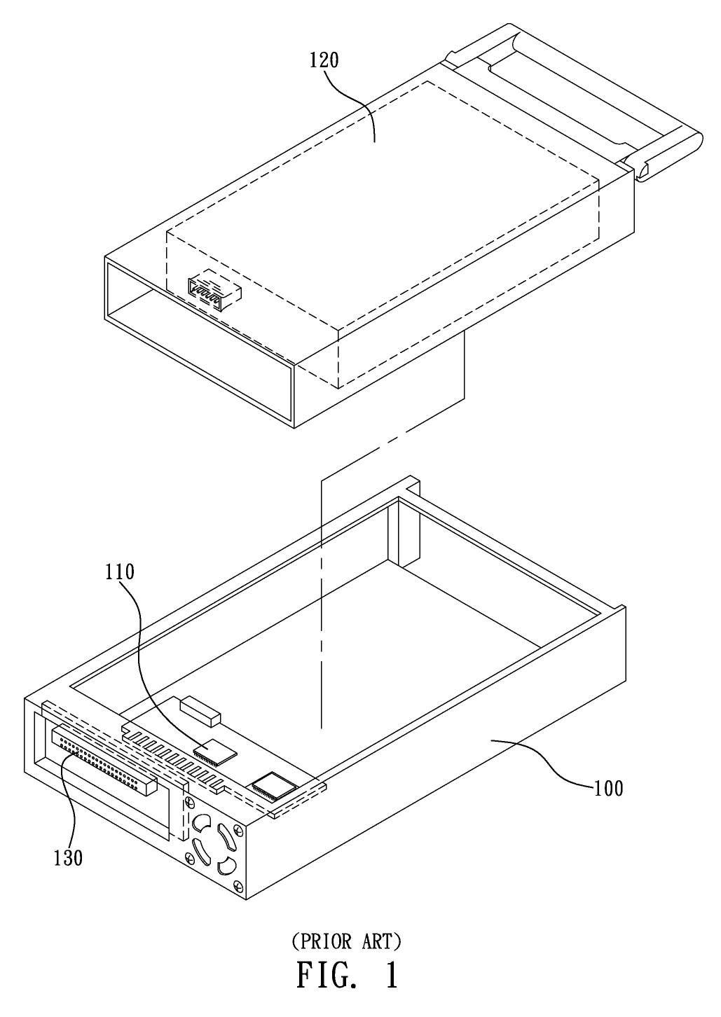

FIG. 2 illustrates a disassembly drawing of the cipher data box in accordance with one embodiment of the present invention.

FIG. 3 illustrates an assembly drawing of the cipher data box in accordance with one embodiment of the present invention.

FIG. 4 illustrates a block diagram of the cipher data box in accordance with one embodiment of the present invention.

FIG. 5 illustrates a block diagram of the key in accordance with one embodiment of the present invention.

FIG. 6a illustrates a perspective diagram of the cipher data box connects to a personal computer in accordance with one embodiment of the present invention.

FIG. 6b illustrates a perspective diagram of the cipher data box connects to a notebook in accordance with one embodiment of the present invention.

FIG. 7 illustrates a perspective diagram of the cipher data box can further cascade to other cipher data boxes in accordance with one embodiment of the present invention.

### DETAILED DESCRIPTION OF THE PREFERRED EMBODIMENTS

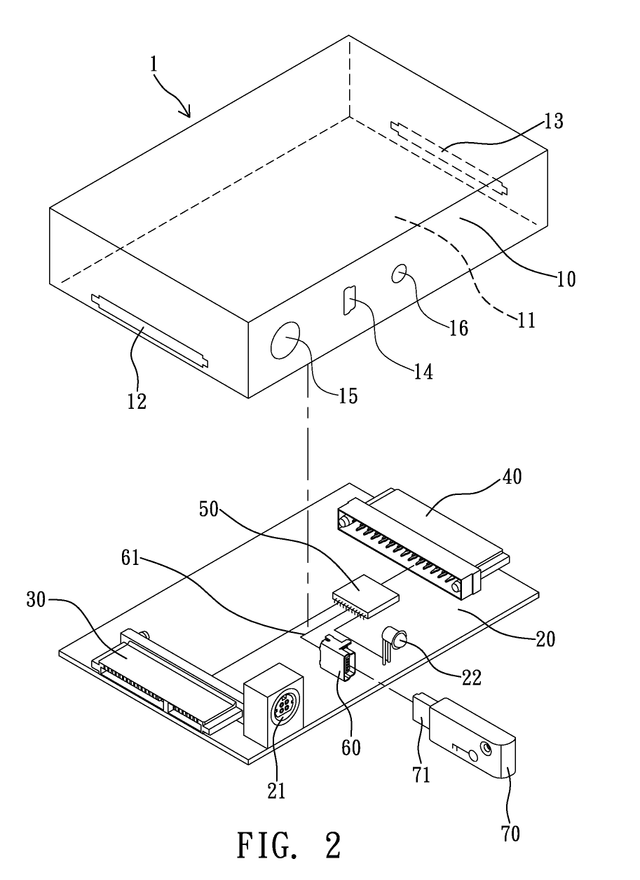

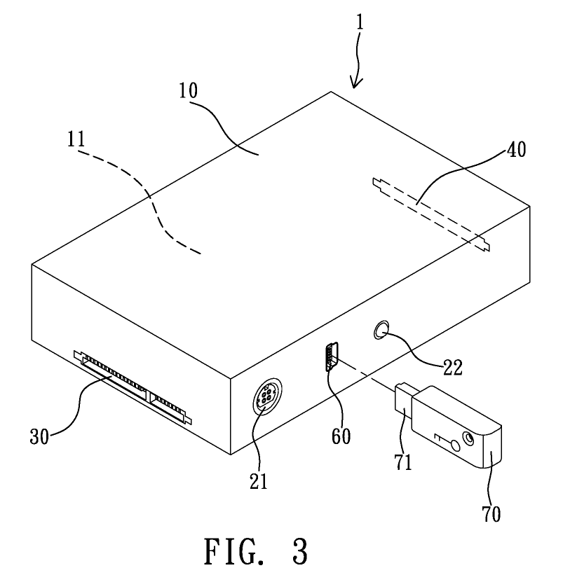

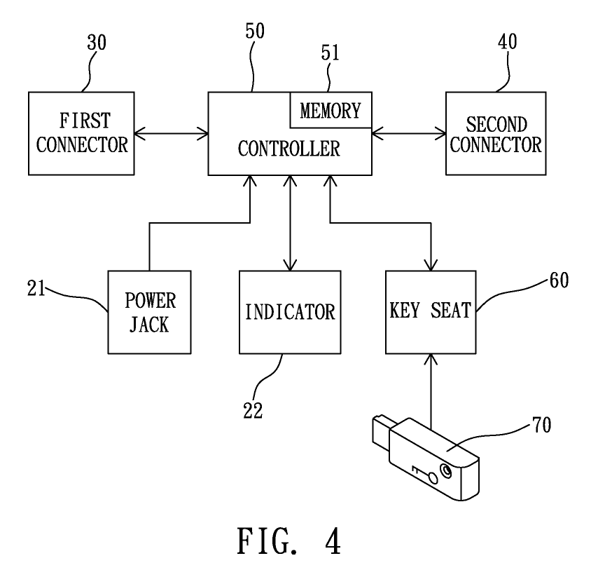

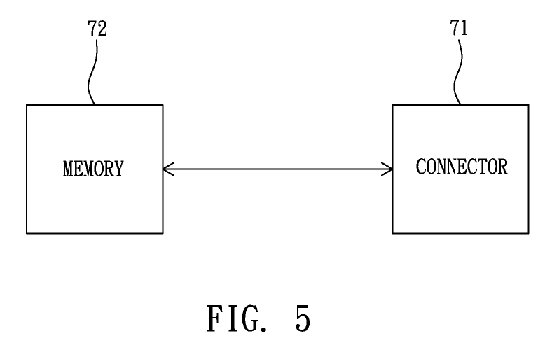

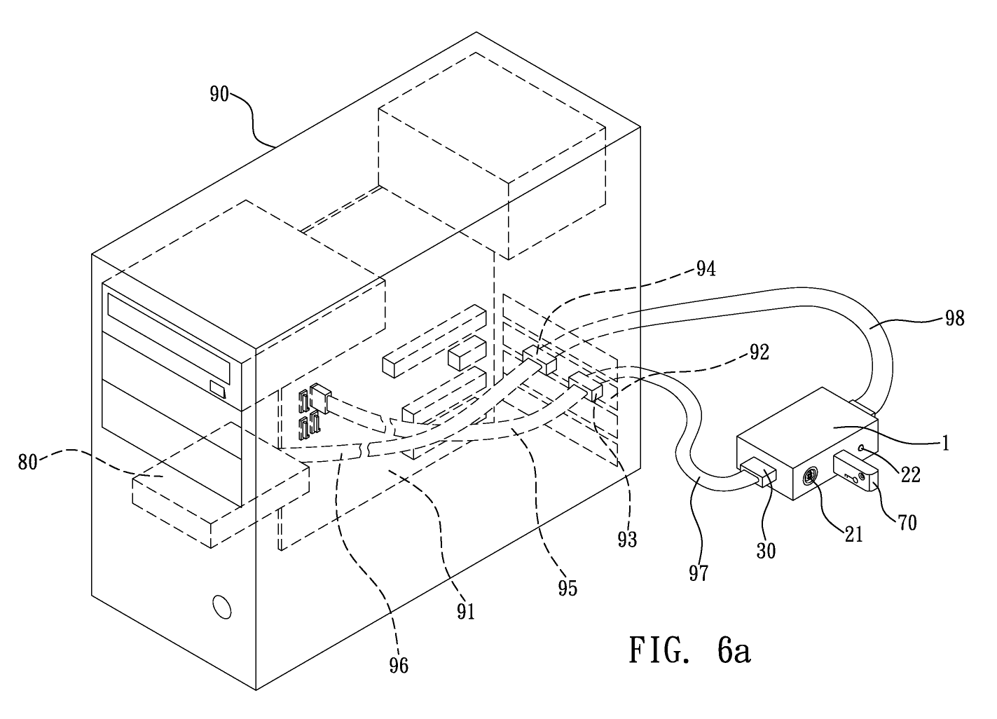

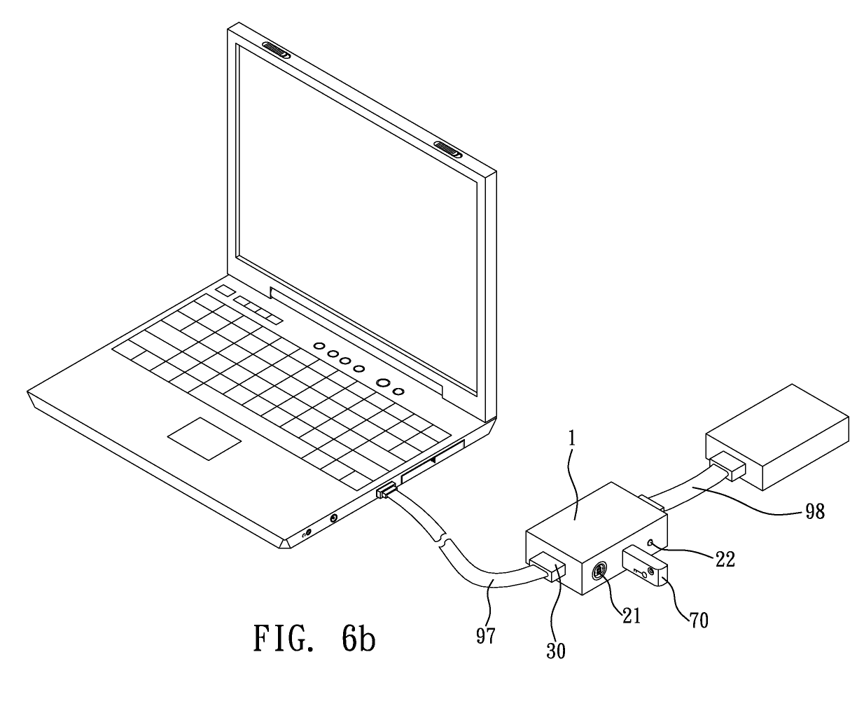

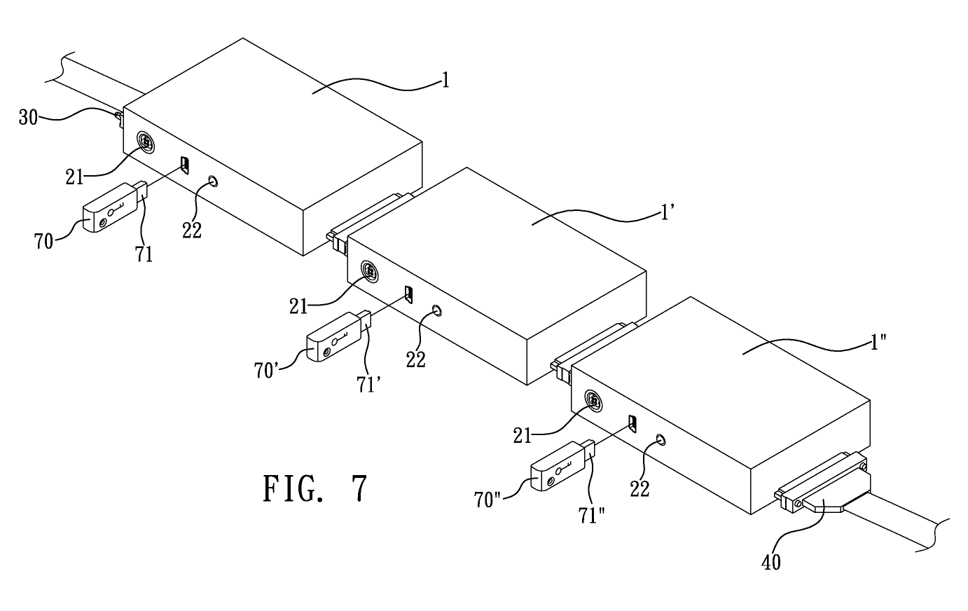

Referring to FIG. 2˜7 simultaneously, wherein FIG. 2 illustrates a disassembly drawing of the cipher data box in accordance with one embodiment of the present invention; FIG. 3 illustrates an assembly drawing of the cipher data box in accordance with one embodiment of the present invention; FIG. 4 illustrates a block diagram of the cipher data box in accordance with one embodiment of the present invention; FIG. 5 illustrates a block diagram of the key in accordance with one embodiment of the present invention.; FIG. 6a illustrates a perspective diagram of the cipher data box connects to a computer or equipment in accordance with one embodiment of the present invention; FIG. 6b illustrates a perspective diagram of the cipher data box connects to a notebook in accordance with one embodiment of the present invention; and FIG. 7 illustrates a perspective diagram of the cipher data box can further cascade to other cipher data boxes in accordance with one embodiment of the present invention

As shown in the Figs., the cipher data box 1 of the present invention that can encrypt/decrypt the data of a storage device of a computer or equipment, comprising: a housing 10; a printed circuit board 20; a first connector 30; a second connector 40; a controller 50; a key seat 60; and a key 70.

Wherein, the housing 10 comprises a space 11 for containing the printed circuit board 20, and comprises at least one opening 12, 13 and a hole 14, for the purpose of illustrating, the embodiment uses two opening 12, 13 as an example, but it will not limit the scope of the present invention. Additionally, the housing 10 is made by for example but not limited to a metal or plastic material. Furthermore, the housing 10 of the present invention further comprises holes 15, 16.

The printed circuit board 20 is disposed in the space 11 for placing the first connector 30, second connector 40, controller 50 and key seat 60 etc.

The first connector 30 is disposed on the printed circuit board 20 and exposed the opening 12, for connecting to a storage device 80, for example but not limited to a hard disk driver (HDD) or Solid State Disk (SSD), for the purpose of illustration, the present invention uses the hard disk driver (HDD) as an example, but it will not limited the scope of the present invention. Wherein, the first connector 30 is for example but not limited to a SATA, eSATA, IDE, SCSI, Firewire or USIB interface connector.

The second connector 40 is disposed on the printed circuit board 20 and exposed the opening 13, for connecting to a control circuit (not shown), for example but not limited to a SATA, eSATA, IDE, SCSI, Firewire or USIB control circuit, of a computer or equipment 90.

The controller 50 is disposed on the printed circuit board 20 and connected to the first connector 30 and second connector 40, respectively for encrypting/decrypting the data of the storage device 80 then outputting. The encrypting/decrypting protocol is for example but not limited to a DES, TDES or AES protocol. Wherein the DES uses 64 bits to encrypt/decrypt the data, the TDES uses 128 or 192 bits to encrypt/decrypt the data, the AES uses 128, 192 or 256 bits to encrypt/decrypt the data. Furthermore, the controller 50 of the present invention is for example but not limited to an ASIC with encrypting/decrypting function, and has a unique first identification code (unique ID), as well as the first identification code of every controller 50 is different. Additionally, the controller 50 further comprises a memory 51 to store the first identification code, wherein the memory 51 is for example but not limited to a EPROM, flash memory or EEPROM.

The key seat 60 is exposed the hole 14 and connected to the controller 50 via wires 61, and the key seat 60 is for example but not limited to a mini USB connector.

The key 70 for inserting into the key seat 60 further comprises a printed circuit board (not shown), a connector 71 and a memory 72, wherein the printed circuit board is used to convey the connector 71 and the memory 72, the connector 71 is for example but not limited to a mini USB plug, for connecting to the key seat 60, as well the memory 72 is coupled to the connector 71 for storing a unique second identification code. Wherein the memory 72 is for example but not limited to a EPROM, flash memory or EEPROM. The unique second identification code is generated by a key code generator (not shown) according to the DES, TDES or AES protocol then stored in the memory 72. The key code generator does not only generate the unique second identification code but also keep the unique second identification code.

Furthermore, the printed circuit board 20 of the present invention further comprises a power jack 21 exposed the hole 15, for connecting to an external power adapter (not shown) for providing the necessary power.

Furthermore, the printed circuit board 20 of the present invention further comprises an indicator 22 disposed on the printed circuit board 20 and coupled to the controller 50 as well as exposed the hole 16 for indicating the status of Power, Cipher key On, as well as HDD Access Status. Wherein the indicator 22 is for example but not limited to a multi-color LED or a single color LED. When the indicator 22 is a multi-color LED, it can indicate the Power, Cipher key On, as well as HDD Access Status by various colors, for example red color indicates the Power status, green color indicates the Cipher key On status, and yellow color indicates the HDD Access Status.

When the indicator 22 is a single color LED, it needs 3 indicators 22 to indicate the Power, Cipher key On, as well as HDD Access Status, respectively. For example, the red color indicates the Power status, the green color indicates the Cipher key On status, and the yellow color indicates the HDD Access Status. For the purpose of illustrating, the embodiment uses a multi-color LED as an example, but it will not limit the scope of the present invention.

The cipher data box 1 of the present invention can be used to encrypt/decrypt the data of an internal storage device 80. As shown in FIG. 6a, user can use a blanket 92 with a first connector 93 and a second connector 94 of the computer or equipment 90, such as personal computer, wherein the first connector 93 is connected to the control circuit (not shown) on the mother board 91 of the computer or equipment 90 by a cable 95, and the storage device 80 is disposed in the computer or equipment 90; the second connector 94 is connected to the storage device 80 by a cable 96, then uses a cable 97 to connect the first connector 30 of the cipher data box 1 and the first connector 93, and uses a cable 98 to connect the second connector 40 of the cipher data box 1 and the second connector 94, thus, when the computer or equipment 90 is turned on, and the key 70 is inserted into the key seat 60, the controller 50 will read the second identification code of the key 70 from the memory 72, then copy the second identification code to the first identification code of the memory 51 so as to synchronize the first identification code and the second identification code, when the power is turned on, the controller 50 will start to encrypt/decrypt the data to or from the storage device 80 according to the second identification code of the key 70, so that the computer or equipment 90 can normally access the data of the storage device 80.

If the cipher data box 1 is lost, the user can buy a new cipher data box 1 with a new key 70, and the new cipher data box 1 comprises a new first identification code. The user can insert the original key 70 into the key seat 60, the controller 50 will read the second identification code of the original key 70 from the memory 72, then copy the second identification code to the new first identification code of the memory 51 so as to synchronize the new first identification code and the second identification code, when the power is turned on, the controller 50 will start to encrypt/decrypt the data to or from the storage device 80 according to the second identification code of the original key 70, so that the computer or equipment 90 can normally access the data of the storage device 80.

If the user inserts the new key 70 into the key seat 60, the controller 50 will read the second identification code of the new key 70, and the controller 50 will synchronize the new second identification code of the new key 70 to the first identification code, when the power is turned on, the controller 50 will start to encrypt/decrypt the data to or from the storage device 80 according to the new second identification code, but the new second identification code is different to the original second identification code, so that the new cipher data box 1 can not recognize the data stored in the storage device 80 and encrypted by the original second identification code, therefore the computer or equipment 90 can not access the data of the storage device 80, so as to protect the data of the storage device 80 from being illegally accessed.

The cipher data box 1 of the present invention can be used to encrypt/decrypt the data of an external storage device 80. As shown in FIG. 6b, user can use the cable 97 connecting between the I/O port (not shown) of the computer or equipment 90 and the first connector 30, wherein the computer or equipment 90 is for example but not limited to a notebook computer and the I/O port is for example but not limited to a USB or SATA port, and uses the cable 98 connecting between the second connector 40 and an external storage device 80, thus, when the computer or equipment 90 is turned on, and the key 70 is inserted into the key seat 60, the controller 50 will read the second identification code of the key 70, and the controller 50 will synchronize the second identification code to the first identification code, when the power is turned on, the controller 50 will start to encrypt/decrypt the data to or from the storage device 80 according to the second identification code of the key 70, so that the computer or equipment 90 can normally access the data of the storage device 80.

As shown in FIG. 7, for further enhancing the security function of the storage device 80, a plurality of cipher data boxes 1, 1′, 1″ of the present invention can be cascaded each other. For the purpose of illustrating, the embodiment uses three cipher data boxes 1, 1′, 1″ as an example, but it will not limit the scope of the present invention.

User can inserts the key 70, 70′, 70″ into the corresponding key seat 60 of every cipher data box 1, 1′, 1″, respectively, and the controller 50 of each cipher data box 1, 1′, 1″ will read the second identification code of the key 70, 70′, 70″, respectively, and the controller 50 will synchronize the second identification code to the first identification code, then the controller 50 will compare its first identification code and the second identification code, if all the first identification codes are same as and second identification codes, the controller 50 of every cipher data box 1, 1′, 1″ will start to encrypt/decrypt the data to or from the storage device 80, so that the computer or equipment 90 can normally access the data of the storage device 80. If one of the first identification code is not same as the second identification code (for example the key 70′ of the second cipher data box 1′), its corresponding controller 50 will not output data; therefore, the computer or equipment 90 cannot normally access the data of the storage device 80, so as to enhance the security function of the storage device 80.

While the invention has been disclosed with reference to preferred embodiments thereof, it is to be understood that modifications or variations may be easily made without departing from the spirit of this invention, which is defined in the appended claims.

What is claimed is:

1. A cipher data box that can encrypt/decrypt the data of a storage device of a computer or equipment, comprising:
a housing, having a space and at least one opening and a hole;
a printed circuit board, disposed in said space;
a first connector, disposed in said printed circuit board and exposed said opening, for connecting to a storage device;
a second connector, disposed in said printed circuit board and exposed said opening, for connecting to a storage device control circuit of said computer or equipment;
a controller, disposed in said printed circuit board and connecting to said first connector and second connector, respectively, for encrypting/decrypting data of said storage device then outputting, and having a unique first identification code;
a key seat, exposed said hole, and connecting to said controller via wires; and
a key, for inserting into said key seat, having a unique second identification code;
thereby, when said key is inserted into said key seat and said first identification code is same as said second identification code, said storage device can be accessed, and data of said storage device will be encrypted/decrypted.

2. The cipher data box according to claim 1, wherein said housing is made by a metal or plastic material.

3. The cipher data box according to claim 1, wherein said first connector is a SATA, eSATA, IDE, SCSI, Firewire or USIB interface connector.

4. The cipher data box according to claim 1, wherein said second connector is a SATA, eSATA, IDE, SCSI, Firewire or USIB interface connector.

5. The cipher data box according to claim 1, wherein said controller uses DES, TDES or AES protocol to encrypt/decrypt data.

6. The cipher data box according to claim 1, wherein said controller is an ASIC chip.

7. The cipher data box according to claim 1, wherein said printed circuit board further comprises a power jack exposed said hole, for connecting to an external power adapter for providing the necessary power.

8. The cipher data box according to claim 1, wherein said printed circuit board further comprises an indicator disposed on said printed circuit board and coupled to said controller for indicating a status of Power, Cipher key On, as well as HDD Access Status.

9. The cipher data box according to claim 8, wherein said indicator is a multi-color LED or a single color LED; when said indicator is a multi-color LED, it can indicate said Power, Cipher key On, as well as HDD Access Status by various colors; when said indicator is a single color LED, it can indicate one of said Power, Cipher key On, as well as HDD Access Status.

10. The cipher data box according to claim 1, wherein a plurality of said cipher data boxes can be cascaded each other by said first connector and said second connector, and when the second identification code of every key is same as said first identification code of every controller, every controller will start to encrypt/decrypt the data to or from said storage device, so that said computer or equipment can normally access the data of said storage device.

11. The cipher data box according to claim 1, wherein said key seat is a mini USB connector.

12. The cipher data box according to claim 1, wherein said key further comprises:
a printed circuit board;
a connector, disposed on the printed circuit board for connecting to said key seat: and
a memory, disposed on the printed circuit board and coupled to said connector for storing said second identification code.

13. The cipher data box according to claim 12, wherein said connector is a mini USB plug.

14. The cipher data box according to claim 12, wherein said memory is a EEPROM, EPROM or a flash memory.

15. The cipher data box according to claim 1, wherein said controller further comprises a memory for storing said first identification code.

16. The cipher data box according to claim 15, wherein said memory is a EEPROM, EPROM or a flash memory.
